(19) United States
(12) Patent Application Publication
(10) Pub. No.: US 2026/0133914 A1
(43) Pub. Date: May 14, 2026

(54) DYNAMIC CONTROL DEVICE AND DYNAMIC CONTROL METHOD

(71) Applicant: MEDIATEK INC., Hsinchu City (TW)

(72) Inventor: Chia-Wei CHANG, Hsinchu City (TW)

(21) Appl. No.: 19/372,655

(22) Filed: Oct. 29, 2025

Related U.S. Application Data
(60) Provisional application No. 63/720,238, filed on Nov. 14, 2024.

(51) Int. Cl. G06F 13/12; G06F 11/14

(52) U.S. Cl. CPC G06F 13/124; G06F 11/1405; G06F 2213/0026

(57) ABSTRACT

A dynamic control device includes a first controller and a processor. The processor is configured to execute following steps based on a plurality of instructions from a memory: obtaining a first state or a second state of a state machine; triggering a change signal by the first controller when the state machine is in the first state; and outputting an initiation signal by the first controller when the state machine is transitioning from the second state to the first state. The first controller is related to a peripheral component interconnect express (PCIe). The initiation signal is related to the change signal.

### CROSS REFERENCE TO RELATED APPLICATIONS

This Application claims priority of US Patent Application No. 63/720,238, filed on November 14, 2024, the entirety of which is incorporated by reference herein.

### BACKGROUND OF THE INVENTION

### Field of the Invention

The present invention relates to a control device and control method, and, in particular, it is related to a dynamic control device and dynamic control method.

### Description of the Related Art

At present, higher link speed and a greater number of lanes provide higher bandwidth. However, establishing a PCIe link at higher speed or with more lanes results in increased power consumption. Therefore, the number of lanes and the link speed can be dynamically adjusted to optimize power consumption according to current system requirements.

In addition, in existing link speed change procedures, the device typically initiates a retraining process through the Root Complex (RC) of the PCIe by configuring the configuration space. From a technical perspective, it is generally difficult to adjust power consumption based on different usage scenarios.

Accordingly, there is a need for a dynamic control device capable of adjusting power consumption under various usage scenarios, which represents an urgent subject for research and development.

### BRIEF SUMMARY OF THE INVENTION

An embodiment of the present invention provides a dynamic control device. The dynamic control device includes a first controller and a processor. The processor is configured to execute following steps based on a plurality of instructions from a memory: obtaining a first state or a second state of a state machine; triggering a change signal by the first controller when the state machine is in the first state; and outputting an initiation signal by the first controller when the state machine is transitioning from the second state to the first state. The first controller is related to a peripheral component interconnect express (PCIe). The initiation signal is related to the change signal.

In one embodiment, the first controller comprises an endpoint of the peripheral component interconnect express (PCIe); wherein the processor comprises a system on chip (SoC); wherein the state machine comprises a Link Training and Status State Machine (LTSSM).

In one embodiment, the processor further executes the following steps based on the plurality of instructions from the memory: during a first mode, triggering the change signal by an endpoint when the state machine is in the first state; during the first mode, outputting an initiation signal by the endpoint when the state machine is transitioning from the second state to the first state; wherein the endpoint is corresponding to the first controller.

In one embodiment, the processor further executes the following steps based on the plurality of instructions from the memory: during a second mode, outputting the initiation signal by the endpoint when the state machine is in the first state or the second state; wherein the second mode is different from the first mode.

In one embodiment, the processor further executes the following steps based on the plurality of instructions from the memory: during a delayed mode, sending the initiation signal by the endpoint while the state machine is transitioned into a recovery state; wherein the recovery state corresponds to a retrain state from an L1 state or a resume state from the L1 state.

In one embodiment, the processor further executes the following steps based on the plurality of instructions from the memory: during a direct mode, sending the initiation signal immediately to a speed change procedure by the endpoint regardless of a current state of the state machine; wherein the speed change procedure is related to the change signal.

In one embodiment, the processor further executes the following steps based on the plurality of instructions from the memory: obtaining a requirement threshold value by an arbitration software according to a first user device and a second user device; wherein the first user device includes one of a software engine, a hardware involved in Direct Memory Access (DMA), a logging service, a control plan, and a data plane.

In one embodiment, the processor further executes the following steps based on the plurality of instructions from the memory: calculating a minimum threshold value by the arbitration software according to a first throughput of the first user device and a second throughput of the second user device; wherein the second user device comprises one of the software engine, the hardware involved in Direct Memory Access (DMA), the logging service, the control plan, and the data plane.

In one embodiment, the minimum threshold value is greater than or equal to a sum of the first throughput of the first user device and the second throughput of the second user device.

In one embodiment, the processor further executes the following steps based on the plurality of instructions from the memory: determining whether an accumulated throughput requirement is greater than the minimum threshold value; when it is determined that the accumulated throughput requirement is greater than the minimum threshold value, triggering a first speed change signal or a first lane change signal to upgrade a link speed or a lane count between the first controller and a second controller; and when it is determined that the accumulated throughput requirement is smaller than the minimum threshold value, triggering a second speed change signal or a second lane change signal to reduce the link speed or the lane count between the first controller and the second controller.

Other embodiment of the present invention provides a dynamic control method. The dynamic control method includes the following steps: obtaining a first state or a second state of a state machine; triggering a change signal by a first controller when the state machine is in the first state; and outputting an initiation signal by the first controller when the state machine is transitioning from the second state to the first state. The first controller is related to a peripheral component interconnect express (PCIe). The initiation signal is related to the change signal.

In one embodiment, the first controller includes an endpoint of the peripheral component interconnect express (PCIe); wherein the processor includes a system on chip (SoC); wherein the state machine includes a Link Training and Status State Machine (LTSSM).

In one embodiment, the dynamic control method further includes the following steps: during a first mode, triggering the change signal by an endpoint when the state machine is in the first state; during the first mode, outputting an initiation signal by the endpoint when the state machine is transitioning from the second state to the first state; wherein the endpoint is corresponding to the first controller.

In one embodiment, the dynamic control method further includes the following steps: during a second mode, outputting the initiation signal by the endpoint when the state machine is in the first state or the second state; wherein the second mode is different from the first mode.

In one embodiment, the dynamic control method further includes the following steps: during a delayed mode, sending the initiation signal by the endpoint while the state machine is transitioned into a recovery state; wherein the recovery state corresponds to a retrain state from an L1 state or a resume state from the L1 state.

In one embodiment, the dynamic control method further includes the following steps: during a direct mode, sending the initiation signal immediately to a speed change procedure by the endpoint regardless of a current state of the state machine; wherein the speed change procedure is related to the change signal.

In one embodiment, the dynamic control method further includes the following steps: obtaining a requirement threshold value by an arbitration software according to a first user device and a second user device; wherein the first user device includes one of a software engine, a hardware involved in Direct Memory Access (DMA), a logging service, a control plan, and a data plane.

In one embodiment, the dynamic control method further includes the following steps: calculating a minimum threshold value by the arbitration software according to a first throughput of the first user device and a second throughput of the second user device; wherein the second user device includes one of the software engine, the hardware involved in Direct Memory Access (DMA), the logging service, the control plan, and the data plane.

In one embodiment, the minimum threshold value is greater than or equal to a sum of the first throughput of the first user device and the second throughput of the second user device.

In one embodiment, the dynamic control method further includes the following steps: determining whether an accumulated throughput requirement is greater than the minimum threshold value; when it is determined that the accumulated throughput requirement is greater than the minimum threshold value, triggering a first speed change signal or a first lane change signal to upgrade a link speed or a lane count between the first controller and a second controller; and when it is determined that the accumulated throughput requirement is smaller than the minimum threshold value, triggering a second speed change signal or a second lane change signal to reduce the link speed or the lane count between the first controller and the second controller.

Therefore, according to the technical content of the present disclosure, the dynamic control device and dynamic control method shown in the embodiment of the present disclosure may achieve power saving through the PCIe controller (also referred to as an endpoint of PCIe) and/or software according to different usage scenarios.

Upon reviewing the embodiments described below, a person of ordinary skill in the art will readily understand the basic spirit of the present invention, other objectives of the invention, as well as the technical means and embodiments adopted in the present invention.

Other features and aspects of the present disclosure will become apparent from the following detailed description of exemplary embodiments with reference to the accompanying drawings.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a dynamic control device according to one embodiment of the present disclosure.

FIG. 2 is an usage scenario of a dynamic control device according to one embodiment of the present disclosure.

FIG. 3 is flowchart of a plurality of steps of a dynamic control method according to one embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

To make the description of the present disclosure more detailed and complete, illustrative descriptions are provided below for the implementation aspects and specific embodiments of the present case. However, this is not the sole form of implementing or utilizing the specific embodiments of the present case. The embodiments cover the features of multiple specific embodiments as well as the method steps and their sequence for constructing and operating these specific embodiments. Nevertheless, the same or equivalent functions and sequence of steps can also be achieved using other specific embodiments.

Unless otherwise defined in this specification, the meaning of scientific and technical terms used herein is the same as commonly understood and customary by a person having ordinary skill in the art to which the present case pertains. Furthermore, without conflicting with the context, singular nouns used in this specification cover their plural forms; and plural nouns also cover their singular forms.

In some embodiments of the present disclosure, terms related to joining and connecting, such as "connect," "interconnect," and "bond," unless specifically defined otherwise, may refer to situations where two structures are in direct contact, or may also refer to situations where two structures are not in direct contact, with other structures arranged between these two structures. Moreover, these terms related to connecting and joining may also include cases where both structures are movable, or both structures are fixed. Additionally, "coupled" or "connected" as used herein may refer to two or more components being in direct physical or electrical contact with each other, or indirect physical or electrical contact with each other, and may also refer to two or more components interacting or operating with each other.

Some embodiments of the present disclosure can be understood in conjunction with the drawings, and the drawings of the embodiments of the present disclosure are also considered as part of the description of the embodiments of the present disclosure. It should be understood that the drawings of the embodiments of the present disclosure are not drawn to the actual scale of devices and components. The shapes and thicknesses of the embodiments may be exaggerated in the drawings to clearly illustrate the features of the embodiments of the present disclosure. Furthermore, the structures and devices in the drawings are schematically illustrated to clearly illustrate the features of the embodiments of the present disclosure.

Herein, the term "apparatus" generally refers to an object connected in a certain way to process signals, composed of one or more transistors and/or one or more active/passive components.

Here, the terms "about," "approximately," and "roughly" generally indicate within 20% of a given value or range, preferably within 10%, and more preferably within 5%, or within 3%, or within 2%, or within 1%, or within 0.5%. The quantities given herein are approximate quantities, meaning that the meaning of "about," "approximately," or "roughly" may still be implicitly included even without specific mention of "about," "approximately," or "roughly". The term "a range between a first value and a second value" means that the described range includes the first value, the second value, and other values between them. Furthermore, a certain error may exist between any two values or directions used for comparison. If the first value is equal to the second value, it implies that there may be an error of about 10%, or within 5%, or within 3%, or within 2%, or within 1%, or within 0.5% between the first value and the second value. If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

Certain terms will be used throughout the entire specification and claims of the present disclosure to refer to specific components. A person having ordinary skill in the art should understand that electronic device manufacturers may refer to the same components by different names. This document is not intended to distinguish between components that have the same function but different names. In the following specification and claims, terms such as "comprising," "containing," and "having" are open-ended terms, and therefore they should be interpreted as "containing but not limited to...". Thus, when the terms "comprising," "containing," and/or "having" are used in the description of the present disclosure, they specify the presence of corresponding parts, regions, steps, operations, and/or elements, but do not exclude the presence of one or more corresponding parts, regions, steps, operations, and/or elements.

It should be understood that the components from multiple different embodiments can be substituted, rearranged, and combined to complete other embodiments without departing from the spirit of the present disclosure. Components between various embodiments can be arbitrarily combined and used together, as long as they do not violate the spirit of the invention or conflict with each other.

Unless otherwise defined, all terms used herein (including technical and scientific terms) have the same meaning as commonly understood by a person having ordinary skill in the art to which the present disclosure pertains. It can be understood that these terms, for example, terms defined in commonly used dictionaries, should be interpreted as having a meaning consistent with the relevant art and the background or context of the present disclosure, and should not be interpreted in an idealized or overly formal sense, unless specifically defined in the embodiments of the present disclosure.

In the present disclosure, various directions are not limited to the three axes like the X-axis, Y-axis, and Z-axis of a Cartesian coordinate system, and can be interpreted in a broader sense. For example, the X-axis, Y-axis, and Z-axis may be perpendicular to each other, or may represent different directions that are not perpendicular to each other, but are not limited thereto. For convenience of description, hereinafter, the X-axis direction is the first direction (width direction), the Y-axis direction is the second direction (length direction), and the Z-axis direction is the third direction (thickness or height direction). In some embodiments, the cross-sectional schematic view described herein is a cross-sectional schematic view observed in the XZ plane. In some embodiments, the third direction may be the normal direction of the substrate. In some embodiments, the third direction may be the front direction of the dynamic control device.

In some embodiments, additional components may be added to the dynamic control device of the present disclosure. In some embodiments, some components of the dynamic control device of the present disclosure may be replaced or omitted. In some embodiments, additional operational steps may be provided before, during, and/or after the manufacturing method of the dynamic control device. In some embodiments, some of the described operational steps may be replaced or omitted, and the sequence of some of the described operational steps is interchangeable. Furthermore, it should be understood that some of the described steps may be replaced or deleted for other embodiments of the method. Moreover, in the present disclosure, the number and size of each component in the drawings are for illustrative purposes only, and are not intended to limit the scope of the present disclosure.

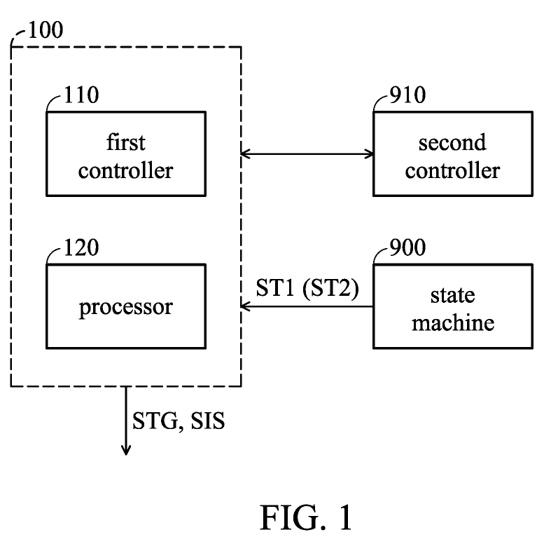

FIG. 1 is a block diagram of a dynamic control device according to one embodiment of the present disclosure. As shown in FIG. 1, in one embodiment, the dynamic control device 100 includes a first controller 110 and a processor 120. Regarding the coupling relationship, the first controller 110 may be coupled to the processor 120.

For example, the processor 120 may obtain a plurality of instructions from a memory, the processor 120 may drive the first controller 110, but the present disclosure is not limited thereto.

In some embodiments, the processor 120 may be a system-on-chip (SoC), microprocessor unit (MPU), central processing unit (CPU), graphics processing unit (GPU), microcontroller unit (MCU), microprocessor, digital signal processor (DSP), field programmable gate array (FPGA), application-specific integrated circuit (ASIC), or a server, but the present disclosure is not limited thereto.

In some embodiments, the memory may be a random-access memory (RAM), read-only memory (ROM), cache memory, flash memory, memory card, hard disk (such as a cloud/network hard disk or an external hard disk), optical disc, USB flash drive, or a database, but the present disclosure is not limited thereto.

In some embodiments, the plurality of instructions may be any type of programming language code, algorithm, software, or firmware, but the present disclosure is not limited thereto.

In one embodiment, the processor 120 is configured to execute following steps based on a plurality of instructions from a memory: obtaining a first state ST1 or a second state ST2 of a state machine 900.

For example, the state machine 900may be related to PCI Express (PCIe), each of the first state and the second state may correspond to one of a L0 state, a L1 state, a L1.2 state, and a recovery state, but the present disclosure is not limited thereto.

In some embodiments, the L0 state may correspond to a normal operation state, the L1 state may correspond to a low-power State, but the present disclosure is not limited thereto.

In some embodiments, the L1.2 state may be a further low-power substate of L1 and the L1.2 state constitutes an extension of Active State Power Management (ASPM), but the present disclosure is not limited thereto.

In some embodiments, the recovery state may be an intermediate state that the link temporarily enters when transitioning between main states such as L0, L1, and L2. The recovery state may be used to retrain link parameters, such as for speed changes, link width adjustments, or error recovery.

In addition, when the device transitions from the L1.2 state back to the L0 state, or retrains from the L2 state, it passes through the recovery state), but the present disclosure is not limited thereto.

In one embodiment, the processor 120 is configured to execute the following steps based on the plurality of instructions from the memory: triggering a change signal STG by the first controller 110 when the state machine 900 is in the first state ST1; and outputting an initiation signal SIS by the first controller 110 when the state machine 900 is transitioning from the second state ST2 to the first state ST1.

For example, the first state ST1 may be the L0 state or the L1 state, the second state ST2 may be the L1.2 state or the L2 state, the change signal may be related to a link speed change of PCIe or a lane change of PCIe, but the present disclosure is not limited thereto.

In some embodiments, the ST1 is sent when entering the next Recovery state (either retrain or resume from L1), but the present disclosure is not limited thereto. In some embodiments, the TS1 for is sent until next recovery state (either retrain or resume from L1), but the present disclosure is not limited thereto.

For example, the TS1 may be a Training Set 1, the TS1 may be related to a Training Sequence signal, the TS1 may be a protocol signaling used for link training, but the present disclosure is not limited thereto.

In some embodiments, if the endpoint of PCIe triggered the speed change during LTSSSM L0 state, the TS1 carrying speed change=1 bit won’t be sent until transitioning from L1.2 to L0, or retrained from L2, but the present disclosure is not limited thereto.

In one embodiment, the first controller 110 is related to a peripheral component interconnect express (PCIe). The initiation signal SIS is related to the change signal STG.

In one embodiment, the first controller 110 includes an endpoint of the peripheral component interconnect express (PCIe). The processor 120 includes a system on chip (SoC). The state machine 900 includes a Link Training and Status State Machine (LTSSM).

For example, the first controller 110 may be the endpoint (EP) of the peripheral component interconnect express (PCIe), the processor 120 may be the system on chip (SoC), the state machine 900 may be the Link Training and Status State Machine (LTSSM), but the present disclosure is not limited thereto.

In some embodiments, the first controller 110 is related to a protocol of the peripheral component interconnect express (PCIe), but the present disclosure is not limited thereto. In some embodiments, the first controller 110 is related to a protocol of an Universal Serial Bus (USB), but the present disclosure is not limited thereto. In some embodiments, the first controller 110 is not related to a protocol of the Universal Serial Bus (USB), but the present disclosure is not limited thereto.

In some embodiments, the first controller 110 may be related to an interface, but the present disclosure is not limited thereto. In some embodiments, the first controller 110 may be related to a connection interface, but the present disclosure is not limited thereto.

In one embodiment, the processor 120 further executes the following steps based on the plurality of instructions from the memory: during a first mode, triggering the change signal STG by an endpoint when the state machine 900 is in the first state ST1; during the first mode, outputting an initiation signal SIS by the endpoint when the state machine 900 is transitioning from the second state ST2 to the first state ST1.

In one embodiment, the endpoint is corresponding to the first controller 110.

For example, the initiation signal SIS may correspond to the TS1 described above, the first mode may be a delayed mode, the endpoint may correspond to the EP of PCIe, but the present disclosure is not limited thereto.

In some embodiments, the endpoint is related to a protocol of the peripheral component interconnect express (PCIe), but the present disclosure is not limited thereto. In some embodiments, the endpoint is related to the protocol of the Universal Serial Bus (USB), but the present disclosure is not limited thereto. In some embodiments, the endpoint is not related to a protocol of the Universal Serial Bus (USB), but the present disclosure is not limited thereto.

In some embodiments, the first controller 110 may be related to the interface, but the present disclosure is not limited thereto. In some embodiments, the first controller 110 may be related to the connection interface, but the present disclosure is not limited thereto.

In one embodiment, the processor 120 further executes the following steps based on the plurality of instructions from the memory: during a second mode, outputting the initiation signal SIS by the endpoint when the state machine 900 is in the first state ST1 or the second state ST2.

In one embodiment, the second mode is different from the first mode.

For example, the second mode may be a direct mode, the endpoint may output the initiation signal SIS regardless of the first state ST1 or the second state ST2 of the state machine 900, but the present disclosure is not limited thereto.

In some embodiments, the TS1 may be sent immediately to initiate the speed change procedure, regardless of current LTSSM state, but the present disclosure is not limited thereto.

In some embodiments, in the dynamic control device 100, the frequency of operating in the second mode may be greater than the frequency of operating in the first mode, but the present disclosure is not limited thereto.

In one embodiment, the processor 120 further executes the following steps based on the plurality of instructions from the memory: during a delayed mode, sending the initiation signal SIS by the endpoint while the state machine 900 is transitioned into a recovery state.

In one embodiment, the recovery state corresponds to a retrain state from an L1 state or a resume state from the L1 state.

For example, the recovery state may be related to the next recovery state described above, but the present disclosure is not limited thereto.

Furthermore, during the delayed mode, the endpoint may send the initiation signal SIS in response to the state machine 900 is transitioned into a recovery state, but the present disclosure is not limited thereto.

In some embodiments, the retrain state from an L1 state may represent that, when resuming from the L1 state, the link may need to perform a retrain, which means renegotiating the link parameters (such as speed, lane count, and synchronization). This typically occurs when the device determines that a “re-establishment of a stable link” is required, but the present disclosure is not limited thereto.

In some embodiments, the resume state from the L1 state may represent that, when resuming from the L1 state, the link may only need to perform a resume (wake-up) without a complete retrain. This usually happens when the device enters the L1 state only for a short duration and then wakes up immediately, without the necessity of performing a full link training again, but the present disclosure is not limited thereto.

In one embodiment, the processor 120 further executes the following steps based on the plurality of instructions from the memory: during a direct mode, sending the initiation signal SIS immediately to a speed change procedure by the endpoint regardless of a current state of the state machine 900.

In one embodiment, the speed change procedure is related to the change signal STG.

In some embodiments, in the dynamic control device 100, the frequency of operating in the delayed mode may be greater than the frequency of operating in the direct mode, but the present disclosure is not limited thereto.

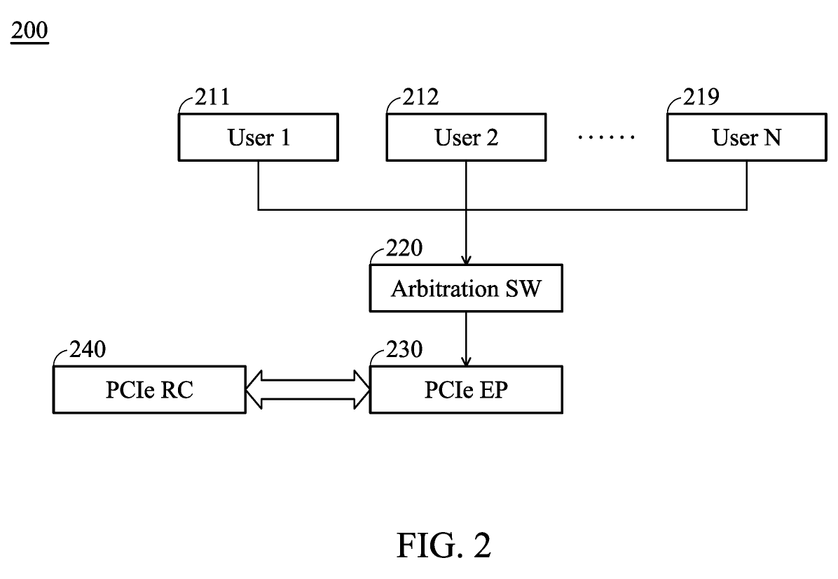

FIG. 2 is an usage scenario of a dynamic control device according to one embodiment of the present disclosure. As shown in FIG. 2, the usage scenario 200 may includes a plurality of device, an Arbitration SW 220, a PCIe EP 230, and a PCIe RC 240.

For example, the plurality of device may include an User 1211, an User 2212, to an User N 219, the Arbitration SW 220 may be stored in the memory described above, the Arbitration SW 220 may be executed by the processor 120 of the dynamic control device 100, the PCIe EP 230 may correspond to the first controller 110 shown in FIG. 1, but the present disclosure is not limited thereto.

Regarding the coupling relationship, each of the plurality of device may be coupled to (or connected to) the Arbitration SW 220, the Arbitration SW 220 may be coupled to (or connected to) the PCIe EP 230, and the PCIe EP 230 may be coupled to (or connected to) the PCIe RC 240, but the present disclosure is not limited thereto.

In some embodiments, the plurality of device (such as the User 1211, the User 2212, to the User N 219) may be a mobile device, but the present disclosure is not limited thereto. In some embodiments, the plurality of device (such as the User 1211, the User 2212, to the User N 219) may be a smart phone, but the present disclosure is not limited thereto.

In some embodiments, the PCIe EP 230 shown in FIG. 2 may correspond to the first controller 110 shown in FIG. 1, the PCIe RC 240 shown in FIG. 2 may correspond to the second controller 910 shown in FIG. 1, but the present disclosure is not limited thereto.

Please refer to FIG. 1 and FIG. 2, in one embodiment, the processor 120 further executes the following steps based on the plurality of instructions from the memory: obtaining a requirement threshold value by an arbitration software according to a first user device and a second user device.

For example, the arbitration software may correspond to the Arbitration SW 220 shown in FIG. 2, the first user device may correspond to the User 1211, the second user device may correspond to the User 2212 or the User N 219, but the present disclosure is not limited thereto.

In one embodiment, the first user device includes one of a software engine, a hardware involved in Direct Memory Access (DMA), a logging service, a control plan, and a data plane.

For example, the first user device may be the software engine, the hardware involved in Direct Memory Access (DMA), the logging service, the control plan, or the data plane, but the present disclosure is not limited thereto.

In some embodiments, the arbitration SW 230 may obtain the requirement threshold value based on the User 1211 and the User 2212, but the present disclosure is not limited thereto.

In one embodiment, the processor 120 further executes the following steps based on the plurality of instructions from the memory: calculating a minimum threshold value by the arbitration software according to a first throughput of the first user device and a second throughput of the second user device.

In one embodiment, the second user device includes one of the software engine, the hardware involved in Direct Memory Access (DMA), the logging service, the control plan, and the data plane.

For example, the second user device may be the software engine, the hardware involved in Direct Memory Access (DMA), the logging service, the control plan, or the data plane, but the present disclosure is not limited thereto.

In some embodiments, the arbitration SW 230 may calculate the minimum threshold value based on the first throughput of the User 1211 and the second throughput of the User 2212, but the present disclosure is not limited thereto.

In one embodiment, the minimum threshold value is greater than or equal to a sum of the first throughput of the first user device and the second throughput of the second user device.

In one embodiment, the processor 120 further executes the following steps based on the plurality of instructions from the memory: determining whether an accumulated throughput requirement is greater than the minimum threshold value; when it is determined that the accumulated throughput requirement is greater than the minimum threshold value, triggering a first speed change signal or a first lane change signal to upgrade a link speed or a lane count between the first controller 110 and a second controller 910.

In one embodiment, the processor 120 further executes the following steps based on the plurality of instructions from the memory: when it is determined that the accumulated throughput requirement is smaller than the minimum threshold value, triggering a second speed change signal or a second lane change signal to reduce the link speed or the lane count between the first controller 110 and the second controller 910.

For example, the link speed may change from PCIe Gen4 to PCIe Gen2, the lane count may change from x8 to x1, but the present disclosure is not limited thereto. In addition, the link speed may change from PCIe Gen2 to PCIe Gen6, the lane count may change from x4 to x16, but the present disclosure is not limited thereto.

Furthermore, the dynamic control device 100 may change to PCIe Gen2 x1 from PCIe Gen4 x4 according to the speed change signal and/or the lane change signal, but the present disclosure is not limited thereto.

In some embodiments, the arbitration SW 230 may determine whether the accumulated throughput requirement is greater than the minimum threshold value, but the present disclosure is not limited thereto.

In some embodiments, the requirement threshold value may correspond to the minimum threshold value, but the present disclosure is not limited thereto. In some embodiments, the minimum threshold value may be the sum of the first throughput of the first user device and the second throughput of the second user device, with a tolerance, but the present disclosure is not limited thereto.

In some embodiments, the requirement threshold value may be the minimum threshold value with tolerance applied to the sum of the first throughput of the first user device and the second throughput of the second user device, but the present disclosure is not limited thereto.

In some embodiments, the minimum threshold value may have a proportional relationship with the first throughput of the first user device and the second throughput of the second user device, but the present disclosure is not limited thereto.

In some embodiments, the minimum threshold value is proportional to the first throughput of the first user device, but the present disclosure is not limited thereto. In some embodiments, the minimum threshold value is proportional to the second throughput of the second user device, but the present disclosure is not limited thereto.

In some embodiments, the minimum threshold value may be set by the user requirement, but the present disclosure is not limited thereto.

In some embodiments, the minimum threshold value may be related to a hardware specification of the dynamic control device 100, but the present disclosure is not limited thereto.

In some embodiments, each of the first speed change signal, the first lane change signal, the second speed change signal, and the second lane change signal is related to the change signal STG shown in FIG. 1, but the present disclosure is not limited thereto.

In some embodiments, the frequency at which each user advertises their current minimum requirement depends on changes in the user's scenario or throughput. The arbitration software in our device (such as the dynamic control device 100) collects user requirements and calculate a safe throughput number to meet the requirement, but the present disclosure is not limited thereto.

In some embodiments, if the accumulated throughput requirement exceeds the current configuration, it triggers a speed change or lane change to upgrade the link speed or lane count. Conversely, if the requirement is less than the current configuration, it triggers a speed change or lane change to reduce the link speed or lane count, but the present disclosure is not limited thereto.

In some embodiments, the dynamic control device 100 may dynamically adjust the PCIe link speed and lane count according to actual usage scenarios and requirements, thereby reducing unnecessary power consumption, but the present disclosure is not limited thereto.

In some embodiments, the dynamic control device 100 may automatically adjust link parameters while maintaining system performance requirements, achieving an optimal balance between performance and power consumption, but the present disclosure is not limited thereto.

In some embodiments, the dynamic control device 100 may quickly switch link configurations based on different user operations or application scenarios, enhancing system flexibility. The dynamic control device and dynamic control method may reduce the need for conventional retraining procedures via the Root Complex, enabling more immediate and efficient link changes, but the present disclosure is not limited thereto.

In some embodiments, the dynamic control device 100 may manage power consumption to lower heat generation and load during prolonged operation, thereby extending the lifespan of the device hardware, but the present disclosure is not limited thereto.

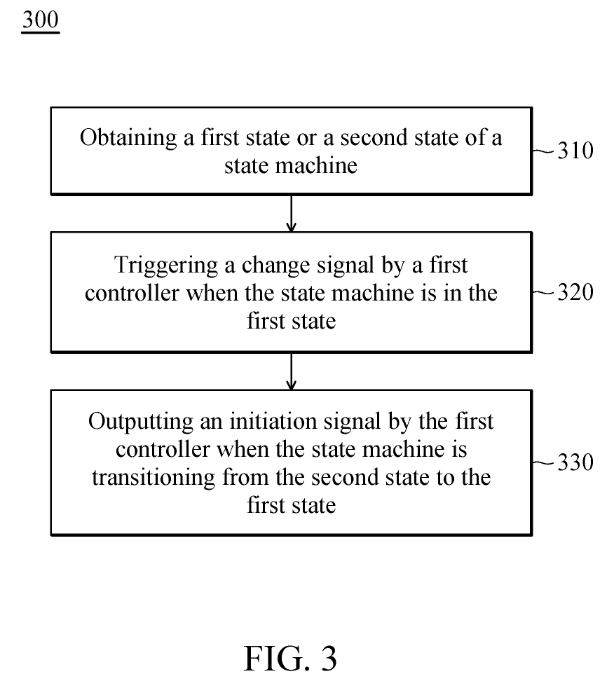

FIG. 3 is flowchart of a plurality of steps of a dynamic control method according to one embodiment of the present disclosure. As shown in FIG. 3, in one embodiment, the dynamic control method 300 includes a plurality of steps 310 to 330.

Please refer to FIG. 1 to FIG. 3, the plurality of steps 310 to 330 will be described in detail below.

In the step 310, obtaining a first state or a second state of a state machine.

In one embodiment, the processor 120 may obtain the first state ST1 or the second state ST2 of the state machine 900.

In the step 320, triggering a change signal by a first controller when the state machine is in the first state.

In one embodiment, the first controller 110 may trigger the change signal STG when the state machine 900 is in the first state ST1.

In the step 330, outputting an initiation signal by the first controller when the state machine is transitioning from the second state to the first state.

In one embodiment, the first controller 110 may output the initiation signal SIS when the state machine 900 is transitioning from the second state ST2 to the first state ST1.

In one embodiment, the first controller 110 is related to a peripheral component interconnect express (PCIe). The initiation signal SIS is related to the change signal.

It should be understood that the above steps do not need to be performed in sequence, and each feature of the embodiments shown in FIG. 1 to FIG. 2 may be applied to the dynamic control method 300 of FIG. 3.

In one embodiment, the first controller 110 includes an endpoint of the peripheral component interconnect express (PCIe). The processor 120 includes a system on chip (SoC). The state machine 900 includes a Link Training and Status State Machine (LTSSM).

In one embodiment, the dynamic control method 300 further includes the following steps: during a first mode, triggering the change signal STG by an endpoint when the state machine 900 is in the first state; during the first mode, outputting an initiation signal SIS by the endpoint when the state machine 900 is transitioning from the second state ST2 to the first state ST1. The endpoint is corresponding to the first controller 110.

In one embodiment, the dynamic control method 300 further includes the following steps: during a second mode, outputting the initiation signal SIS by the endpoint when the state machine 900 is in the first state ST1 or the second state ST2. The second mode is different from the first mode.

In one embodiment, the dynamic control method 300 further includes the following steps: during a delayed mode, sending the initiation signal SIS by the endpoint while the state machine 900 is transitioned into a recovery state. The recovery state corresponds to a retrain state from an L1 state or a resume state from the L1 state.

In one embodiment, the dynamic control method 300 further includes the following steps: during a direct mode, sending the initiation signal SIS immediately to a speed change procedure by the endpoint regardless of a current state of the state machine 900. The speed change procedure is related to the change signal STG.

In one embodiment, the dynamic control method 300 further includes the following steps: obtaining a requirement threshold value by an arbitration software according to a first user device and a second user device. The first user device includes one of a software engine, a hardware involved in Direct Memory Access (DMA), a logging service, a control plan, and a data plane.

In one embodiment, the dynamic control method 300 further includes the following steps: calculating a minimum threshold value by the arbitration software according to a first throughput of the first user device and a second throughput of the second user device. The second user device includes one of the software engine, the hardware involved in Direct Memory Access (DMA), the logging service, the control plan, and the data plane.

In one embodiment, the minimum threshold value is greater than or equal to a sum of the first throughput of the first user device and the second throughput of the second user device.

In one embodiment, the dynamic control method 300 further includes the following steps: determining whether an accumulated throughput requirement is greater than the minimum threshold value; when it is determined that the accumulated throughput requirement is greater than the minimum threshold value, triggering a first speed change signal or a first lane change signal to upgrade a link speed or a lane count between the first controller 110 and a second controller 910; and when it is determined that the accumulated throughput requirement is smaller than the minimum threshold value, triggering a second speed change signal or a second lane change signal to reduce the link speed or the lane count between the first controller 110 and the second controller 910.

In some embodiments, the dynamic control method 300 may be implemented in any type of programming code, algorithm, software, or firmware, but the present disclosure is not limited thereto.

In some embodiments, the dynamic control method 300 may be implemented by the dynamic control device 100, but the present disclosure is not limited thereto. In some embodiments, the dynamic control method 300 may be implemented via a non-transitory computer-readable storage medium, but the present disclosure is not limited thereto. In some embodiments, the dynamic control method 300 may be implemented by other systems or servers, but the present disclosure is not limited thereto.

Therefore, according to the technical content of the present disclosure, the dynamic control device and dynamic control method shown in the embodiment of the present disclosure may achieve power saving through the PCIe controller (also referred to as an endpoint of PCIe) and/or software according to different usage scenarios.

Furthermore, the dynamic control device and dynamic control method shown in the embodiment of the present disclosure may dynamically adjust the PCIe link speed and lane count according to actual usage scenarios and requirements, thereby reducing unnecessary power consumption.

Afterwards, the dynamic control device and dynamic control method may automatically adjust link parameters while maintaining system performance requirements, achieving an optimal balance between performance and power consumption. The dynamic control device and dynamic control method may quickly switch link configurations based on different user operations or application scenarios, enhancing system flexibility.

In addition, the dynamic control device and dynamic control method may reduce the need for conventional retraining procedures via the Root Complex, enabling more immediate and efficient link changes. The dynamic control device and dynamic control method may manage power consumption to lower heat generation and load during prolonged operation, thereby extending the lifespan of the device hardware.

It should be understood that ordinal terms used in the specification and claims, such as “first,” “second,” etc., are employed to modify elements and are not intended to imply or represent any previous order of such elements, nor to indicate any particular sequence between one element and another or in a manufacturing process. The use of such ordinal terms is merely to distinguish elements having a given name from other elements having the same name. The terminology used in the specification and the claims may differ; for example, the first element described in the specification may correspond to the second element in the claims.

The scope of protection disclosed herein is not limited to the specific processes, machines, manufacturing methods, compositions, devices, methods, or steps described in the exemplary embodiments. Those skilled in the art will understand, based on the disclosure herein, that current or future processes, machines, manufacturing methods, compositions, devices, methods, or steps may be developed, provided that they achieve substantially the same functions or results as those described in the embodiments disclosed herein. Accordingly, the scope of the present disclosure includes such processes, machines, manufacturing methods, compositions, devices, methods, and steps. None of the embodiments or claims of the present disclosure need to achieve all of the objectives, advantages, and/or features disclosed herein.

The above embodiments are summarized to facilitate a better understanding of the present disclosure by those skilled in the art. Those skilled in the art should understand that, based on the disclosed embodiments, they can design or modify other processes and structures to achieve the same objectives and/or advantages as those presented herein. Those skilled in the art should also understand that such equivalent processes and structures do not depart from the spirit and scope of the present disclosure, and that various modifications, substitutions, and replacements may be made without departing from the spirit and scope of the disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dynamic control device, comprising:
a first controller; and
a processor, configured to execute following steps based on a plurality of instructions from a memory:
obtaining a first state or a second state of a state machine;
triggering a change signal by the first controller when the state machine is in the first state; and
outputting an initiation signal by the first controller when the state machine is transitioning from the second state to the first state;
wherein the first controller is related to a peripheral component interconnect express (PCIe);
wherein the initiation signal is related to the change signal.

2. The dynamic control device as claimed in claim 1, wherein
the first controller comprises an endpoint of the peripheral component interconnect express (PCIe);
wherein the processor comprises a system on chip (SoC);
wherein the state machine comprises a Link Training and Status State Machine (LTSSM).

3. The dynamic control device as claimed in claim 1, wherein
the processor further executes the following steps based on the plurality of instructions from the memory:
during a first mode, triggering the change signal by an endpoint when the state machine is in the first state; and
during the first mode, outputting the initiation signal by the endpoint when the state machine is transitioning from the second state to the first state;
wherein the endpoint is corresponding to the first controller.

4. The dynamic control device as claimed in claim 3, wherein
the processor further executes the following steps based on the plurality of instructions from the memory:
during a second mode, outputting the initiation signal by the endpoint when the state machine is in the first state or the second state;
wherein the second mode is different from the first mode.

5. The dynamic control device as claimed in claim 1, wherein
the processor further executes the following steps based on the plurality of instructions from the memory:
during a delayed mode, sending the initiation signal by an endpoint while the state machine is transitioned into a recovery state;
wherein the recovery state corresponds to a retrain state from an L1 state or a resume state from the L1 state.

6. The dynamic control device as claimed in claim 1, wherein
the processor further executes the following steps based on the plurality of instructions from the memory:
during a direct mode, sending the initiation signal immediately to a speed change procedure by an endpoint regardless of a current state of the state machine;
wherein the speed change procedure is related to the change signal.

7. The dynamic control device as claimed in claim 1, wherein
the processor further executes the following steps based on the plurality of instructions from the memory:
obtaining a requirement threshold value by an arbitration software according to a first user device and a second user device;
wherein the first user device comprises one of a software engine, a hardware involved in Direct Memory Access (DMA), a logging service, a control plan, and a data plane.

8. The dynamic control device as claimed in claim 7, wherein
the processor further executes the following steps based on the plurality of instructions from the memory:
calculating a minimum threshold value by the arbitration software according to a first throughput of the first user device and a second throughput of the second user device;
wherein the second user device comprises one of the software engine, the hardware involved in the Direct Memory Access (DMA), the logging service, the control plan, and the data plane.

9. The dynamic control device as claimed in claim 7, wherein
the minimum threshold value is greater than or equal to a sum of a first throughput of the first user device and a second throughput of the second user device.

10. The dynamic control device as claimed in claim 7, wherein
the processor further executes the following steps based on the plurality of instructions from the memory:
determining whether an accumulated throughput requirement is greater than the minimum threshold value;
when it is determined that the accumulated throughput requirement is greater than the minimum threshold value, triggering a first speed change signal or a first lane change signal to upgrade a link speed or a lane count between the first controller and a second controller; and
when it is determined that the accumulated throughput requirement is smaller than the minimum threshold value, triggering a second speed change signal or a second lane change signal to reduce the link speed or the lane count between the first controller and the second controller.

11. A dynamic control method, comprising:
obtaining a first state or a second state of a state machine;
triggering a change signal by a first controller when the state machine is in the first state; and
outputting an initiation signal by the first controller when the state machine is transitioning from the second state to the first state;
wherein the first controller is related to a peripheral component interconnect express (PCIe);
wherein the initiation signal is related to the change signal.

12. The dynamic control method as claimed in claim 11, wherein
the first controller comprises an endpoint of the peripheral component interconnect express (PCIe);
wherein a processor comprises a system on chip (SoC);
wherein the state machine comprises a Link Training and Status State Machine (LTSSM).

13. The dynamic control method as claimed in claim 11, further comprising:
during a first mode, triggering the change signal by an endpoint when the state machine is in the first state; and
during the first mode, outputting the initiation signal by the endpoint when the state machine is transitioning from the second state to the first state;
wherein the endpoint is corresponding to the first controller.

14. The dynamic control method as claimed in claim 13, further comprising:
during a second mode, outputting the initiation signal by the endpoint when the state machine is in the first state or the second state;
wherein the second mode is different from the first mode.

15. The dynamic control method as claimed in claim 11, further comprising:
during a delayed mode, sending the initiation signal by an endpoint while the state machine is transitioned into a recovery state;
wherein the recovery state corresponds to a retrain state from an L1 state or a resume state from the L1 state.

16. The dynamic control method as claimed in claim 11, further comprising:
during a direct mode, sending the initiation signal immediately to a speed change procedure by an endpoint regardless of a current state of the state machine;
wherein the speed change procedure is related to the change signal.

17. The dynamic control method as claimed in claim 11, further comprising:
obtaining a requirement threshold value by an arbitration software according to a first user device and a second user device;
wherein the first user device comprises one of a software engine, a hardware involved in Direct Memory Access (DMA), a logging service, a control plan, and a data plane.

18. The dynamic control method as claimed in claim 17, further comprising:
calculating a minimum threshold value by the arbitration software according to a first throughput of the first user device and a second throughput of the second user device;
wherein the second user device comprises one of the software engine, the hardware involved in the Direct Memory Access (DMA), the logging service, the control plan, and the data plane.

19. The dynamic control method as claimed in claim 17, wherein
the minimum threshold value is greater than or equal to a sum of a first throughput of the first user device and a second throughput of the second user device.

20. The dynamic control method as claimed in claim 17, further comprising:
determining whether an accumulated throughput requirement is greater than the minimum threshold value;
when it is determined that the accumulated throughput requirement is greater than the minimum threshold value, triggering a first speed change signal or a first lane change signal to upgrade a link speed or a lane count between the first controller and a second controller; and
when it is determined that the accumulated throughput requirement is smaller than the minimum threshold value, triggering a second speed change signal or a second lane change signal to reduce the link speed or the lane count between the first controller and the second controller.
